(19) United States
(12) Patent Application Publication
(10) Pub. No.: US 2026/0012356 A1
(43) Pub. Date: Jan. 8, 2026

(54) METHOD AND SYSTEM FOR DELEGATION AND VERIFICATION OF DIGITAL CONTENT ENTITLEMENT

(71) Applicant: Tsrct, Inc., Edison, NJ (US)

(72) Inventor: Saurabh GUPTA, Edison, NJ (US)

(21) Appl. No.: 19/240,006

(22) Filed: Jun. 17, 2025

Related U.S. Application Data
(63) Continuation of application No. PCT/CA2023/051735, filed on Dec. 21, 2023.
(60) Provisional application No. 63/435,146, filed on Dec. 23, 2022.

(51) Int. Cl. H04L 9/32; H04L 9/08

(52) U.S. Cl. CPC H04L 9/3247; H04L 9/0825; H04L 9/3213; H04L 9/3271

(57) ABSTRACT

Herein are disclosed systems and methods for delegation and verification of a digital content entitlement, comprising receiving an entitlement registration request from a domain server; receiving an entitlement attachment request from a content creator device; sending the domain server an entitlement affixation request; receiving a single-purpose token from the domain server; sending the content creator device an entitlement attachment acknowledgement; receiving a content package from the content creator device; verifying the content package by confirming a token age between when the single-purpose token was generated by the domain server and when the content package was received by the verification server is less than a threshold token age; receiving an entitlement verification request from a content consumer device; generating an entitlement verification confirmation based at least in part on the entitlement verification request; and sending the entitlement verification confirmation to the content consumer device.

### CROSS-REFERENCE TO RELATED APPLICATIONS

This application is a continuation (bypass application) of International Application No. PCT/CA2023/051735, filed 21 Dec. 2023, entitled “METHOD AND SYSTEM FOR DELEGATION AND VERIFICATION OF DIGITAL CONTENT ENTITLEMENT”, which in turn claims priority from application No. 63/435,146, filed 23 Dec. 2022, entitled “METHOD AND SYSTEM FOR ONLINE VERIFICATION OF INFORMATION PROVENANCE”, both of which are hereby incorporated herein by reference for all purposes.

### TECHNICAL FIELD

The present disclosure is directed to methods and systems of delegation and verification of a digital content entitlement. More particularly, the present disclosure is directed to methods and systems of delegation and verification of a digital content entitlement using cryptography.

### BACKGROUND

The internet and related digital technologies have connected people in many ways, including by real-time communication like audio-calls and video-calls, and by asynchronous communication like person-to-person messaging and by providing platforms to share information. In particular, social media platforms and online websites have proliferated as ways for people to connect and share information online.

Along with the proliferation of online information has been an increase in the creation and spread of misinformation. Misinformation may be intentionally created by bad actors looking to deceive people online, or by accident when careless actors take incomplete information or information out of context.

A particular source of misinformation is bad actors impersonating people and sharing information the bad actor purports to be from the impersonated person, i.e. deceiving information consumers as to the provenance of such information. Given the nature of the internet, such misinformation may be shared broadly and widely long before the impersonated person realizes the misinformation is online. Furthermore, given the decentralized nature of the internet and the speed at which information is shared, it can be almost impossible for an impersonated person to remove misinformation from the internet.

Information consumers are increasingly aware of online misinformation and deceptive providence of information, and in particular the need to verify the quality or provenance of online information before trusting such information. However, the decentralized and informal nature of online information makes verifying the quality or provenance of online information exceptionally difficult, and practically impossible to do in anything more than a small number of cases.

In addition to misinformation, all manner of information exchange, such as receipts, educational credentials, employment history, credit reporting, letters of authorization, job offers, event tickets, etc. are susceptible to falsification and misrepresentation.

Due to the nature of the internet and increasingly sophisticated tools for creating digital content, it is becoming increasingly difficult to detect misleading and/or false content. Online users have no general method for verifying whether the provider of online content was entitled to make some claim regarding the online content, for example an affiliation, a quality, a source, and/or a location of the online content.

Existing methods for verifying the entitlement of a content creator to make a claim regarding online content generally leverage other relationships between parties, for example an in-person relationship such as meeting in person. However, these existing methods are generally limited to closed systems, and cannot scale beyond the limited relationship. Furthermore, these methods often require a single centralized source of authority, which limits the adoption and proliferation of such systems.

There is a general desire for a system and/or method for delegation and verification of a digital content entitlement.

The foregoing examples of the related art and limitations related thereto are intended to be illustrative and not exclusive. Other limitations of the related art will become apparent to those of skill in the art upon a reading of the specification and a study of the drawings.

### SUMMARY

Further aspects and example embodiments are illustrated in the accompanying drawings and/or described in the following description.

One aspect of the invention provides a method performed by a verification server for delegation and verification of a digital content entitlement, the method comprising: receiving an entitlement registration request from a domain server, wherein the entitlement registration request comprises a content creator identifier, and an entitlement characteristic identifier; receiving an entitlement attachment request from a content creator device, wherein the entitlement attachment request comprises the content creator identifier, a digital content identifier corresponding to digital content, and the entitlement characteristic identifier; sending the domain server an entitlement affixation request, wherein the entitlement affixation request comprises the content creator identifier, the digital content identifier, and the entitlement characteristic identifier; receiving a single-purpose token from the domain server, wherein the single-purpose token is associated with the digital content identifier; sending the content creator device an entitlement attachment acknowledgement, wherein the entitlement attachment acknowledgement comprises the digital content identifier and the single-purpose token; receiving a content package from the content creator device, wherein the content package comprises the single-purpose token and the digital content; verifying the content package by confirming a token age between when the single-purpose token was generated by the domain server and when the content package was received by the verification server is less than a threshold token age; receiving an entitlement verification request from a content consumer device, wherein the entitlement verification request comprises the content creator identifier, the digital content identifier, and the entitlement characteristic identifier; generating an entitlement verification confirmation based at least in part on the entitlement verification request; and sending the entitlement verification confirmation to the content consumer device.

Some embodiments of the present invention further comprise: receiving an entitlement challenge request from the content creator device, wherein the entitlement challenge request comprises the content creator identifier, the entitlement characteristic identifier, and a cryptographic signature; retrieving a cryptographic key associated with the content creator identifier; verifying the cryptographic signature of the entitlement challenge request with the cryptographic key; and sending an entitlement challenge confirmation to the content creator device.

Some embodiments of the present invention further comprise: receiving an entitlement challenge request from the content consumer device, wherein the entitlement challenge request comprises a content creator identifier, the entitlement characteristic identifier, and a cryptographic signature; retrieving a cryptographic key associated with the content creator identifier; verifying the cryptographic signature of the entitlement challenge request with the cryptographic key; and sending an entitlement challenge confirmation to the content consumer device.

In some embodiments of the present invention, the entitlement verification confirmation comprises a cryptographic signature, and generating the entitlement verification confirmation based at least in part on the entitlement verification request comprises: retrieving a cryptographic key associated with the content creator identifier, the digital content identifier, and the entitlement characteristic identifier; and verifying the cryptographic signature in the entitlement verification confirmation with the cryptographic key.

In some embodiments of the present invention, generating the entitlement verification confirmation based at least in part on the entitlement verification request comprises retrieving a cryptographic key associated with the content creator identifier, the digital content identifier, and the entitlement characteristic identifier; and sending the entitlement verification confirmation to the content consumer device comprises sending the cryptographic key to the content consumer device.

In some embodiments of the present invention, the entitlement registration request further comprises a cryptographic signature, and the method further comprises: retrieving a cryptographic key associated with the domain server; and verifying the cryptographic signature of the entitlement registration request with the cryptographic key.

In some embodiments of the present invention, the entitlement attachment request further comprises a cryptographic signature, and the method further comprises: retrieving a cryptographic key associated with the content creator identifier; and verifying the cryptographic signature of the entitlement attachment request with the cryptographic key.

In some embodiments of the present invention, sending the domain server an entitlement affixation request comprises: retrieving a cryptographic key associated with the verification server; generating a cryptographic signature from the content creator identifier, the digital content identifier, and the entitlement characteristic identifier with the cryptographic key; and wherein the entitlement affixation request further comprises the cryptographic signature.

In some embodiments of the present invention, the single-purpose token comprises a first cryptographic signature generated at least in part from the content creator identifier, the digital content identifier, and the entitlement characteristic identifier; the content package further comprises a second cryptographic signature generated from the single purpose token and the digital content; and verifying the content package comprises: retrieving a first cryptographic key associated with the content creator identifier, the digital content identifier, and the entitlement characteristic identifier; retrieving a second cryptographic key associated with the content creator identifier; verifying the first cryptographic signature with the first cryptographic key; and verifying the second cryptographic signature with the second cryptographic key

In some embodiments of the present invention, the single-purpose token further comprises a timestamp representing a time when the single-purpose token was generated by the domain server.

In some embodiments of the present invention, the single-purpose token further comprises a nonce, and verifying the content package by confirming the token age comprises calculating a timestamp from the nonce.

Some embodiments of the present invention further comprise verifying the domain server, wherein verifying the domain server comprises: receiving an initiation message from the domain server, wherein the initiation message comprises a domain name of the domain server, and a cryptographic key; retrieving a cryptographic signature from a domain name server record associated with the domain name; verifying the cryptographic signature with the cryptographic key; and sending an acknowledgement message to the domain server.

In some embodiments of the present invention, the entitlement characteristic identifier identifies a characteristic of one ore more of the digital content and the content creator identifier.

In some embodiments of the present invention, the characteristic comprises one or more of: a credential, an affiliation, a source, a location, and a time.

In some embodiments of the present invention, the threshold token age is less than five minutes.

In some embodiments of the present invention, two or more of the entitlement registration request, the entitlement attachment request, the entitlement affixation request, the entitlement attachment acknowledgement, the content package, the entitlement verification request, and the entitlement verification confirmation, comprise a structured document having a header, a body, and a signature generated from the header and the body.

In some embodiments of the present invention, each of the entitlement registration request, the entitlement attachment request, the entitlement affixation request, the entitlement attachment acknowledgement, the content package, the entitlement verification request, and the entitlement verification confirmation, comprise a structured document having a header, a body, and a signature generated from the header and the body.

In addition to the exemplary aspects and embodiments described above, further aspects and embodiments will become apparent by reference to the drawings and by study of the following detailed descriptions.

One aspect of the invention provides a method performed by a domain server for delegation and verification of a digital content entitlement, the method comprising: sending an entitlement registration request to a verification server, wherein the entitlement delegation request comprises a content creator identifier, and an entitlement characteristic identifier; receiving from the verification server an entitlement affixation request, wherein the entitlement affixation request comprises the content creator identifier, a digital content identifier, and the entitlement characteristic identifier; verifying the entitlement affixation request by confirming a delegation of an entitlement represented by the entitlement characteristic identifier to the content creator identifier is active; generating a single-purpose token from the digital content identifier; and sending a single-purpose token to the verification server.

Some embodiments of the present invention further comprise registering the domain server with the verification server, wherein registering the domain server with the verification server comprises: generating a cryptographic signature with a private cryptographic key; storing the cryptographic signature in a domain name server record associated with a domain name of the domain server; sending an initiation message to the verification server, wherein the initiation message comprises the domain name, and a public cryptographic key paired with the private cryptographic key; receiving an acknowledgement message from the verification server.

In some embodiments of the present invention the single-purpose token further comprises a timestamp representing a time when the single-purpose token was generated by the domain server.

### BRIEF DESCRIPTION OF THE DRAWINGS

The accompanying drawings illustrate non-limiting example embodiments of the invention.

FIG. 1 is a schematic diagram of a system for delegation and verification of a digital content entitlement according to an example embodiment of the present invention.

FIG. 2 is a block diagram of a method for delegation and verification of a digital content entitlement according to an example embodiment of the present invention.

FIG. 3A depicts a sample format of a structured document used in a digital content entitlement according to an embodiment of the present invention.

FIG. 3B depicts a sample content of a structured document used in a digital content entitlement according to an embodiment of the present invention.

FIG. 4A depicts an example interaction between an individual and the system according to an embodiment of the present invention.

FIG. 4B depicts an example interaction between an organization and the system according to an embodiment of the present invention.

FIG. 4C depicts an example issue of an official document by an organization according to an embodiment of the present invention.

FIG. 5 depicts an example use case of digital content entitlement verification according to an embodiment of the present invention.

FIG. 6 is a block diagram illustrating the details of a digital processing system in which various aspects of the present disclosure are operative by execution of appropriate executable modules.

In the drawings, like reference numbers generally indicate identical, functionally similar, and/or structurally similar elements. The drawing in which an element first appears is indicated by the leftmost digit(s) in the corresponding reference number.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive sense.

As digital communication technologies such as smartphones and the internet have proliferated, so too have the amount of online content and online platforms providing such content. These platforms host content including digitization of formally offline and trusted content like legacy news media and government media, but also new types of media hosted on platforms like social media and privately hosted websites.

As the amount of online content grows, content consumers have increasing difficulty determining any number of qualities of any given online content. For example, a content consumer may want to verify one or more of:
an identify of a creator of online content;
an affiliation of a creator of online content, for example an affiliation with an individual or an organization such as a governmental agency or news agency;
a credential of an individual they are interacting with online, for example a degree such as a college degree, a license such as a legal license, or an authority granted to the individual such as an investigative or law-enforcement authority;
a source geographic location of online content, for example a location a photograph or video was taken; and
an age of online content
   Any one of which may be referred to as an “entitlement” of the online content.

Any given online content may have multiple entitlements, for example a news article may have one entitlement to the identity of an author of the article, a second entitlement to an affiliation of the article with an organization, and a third entitlement to a date on which the article was first published. A content consumer of said news article may want to verify each of the three entitlements of the article.

As another example, content such as a digital ticket held by an individual may have a first entitlement to the individual's identity, and a second entitlement to the authenticity of the ticket. In such a scenario, an event organizer constitutes the consumer of the digital ticket, and the event organizer may want verification of the digital ticket entitlements to the individual's identity and to authenticity.

Centrally managing the entitlements of online content requires a single source of trustworthiness. In other words, the trustworthiness of all entitlements in a centrally managed systems is based on the trustworthiness of the single system.

The present disclosure is directed to methods and systems for delegation and verification of a digital content entitlement. The delegation of said digital content entitlement facilitates granting of a digital content entitlement wherein the trustworthiness of the digital content entitlement is based on the trustworthiness of the third party.

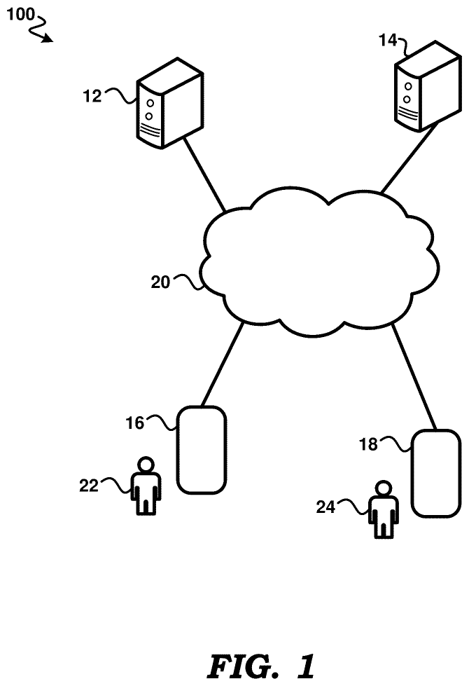

FIG. 1 is a schematic diagram of system 100 for delegation and verification of a digital content entitlement. System 100 comprises verification server 12, domain server 14, content creator device 16, and content consumer device 18. All of verification server 12, domain server 14, content creator device 16, and content consumer device 18 are in communication with each other via a communication network, for example by the internet 20. Content creator device 16 is associated with and controlled by content creator 22, and content consumer device 18 is associated with and controlled by content consumer 24. Content creator 22 and content consumer 24 interact with system 100 respectively with content creator device 16 and content consumer device 18.

Verification server 12 securely communicates with domain server 14 to delegate the authority for content creator 22 to attach one or more digital content entitlements to digital content created with content creator device 16. Content creator 22 may then generate digital content and attach one or more of the digital content entitlements to the digital content to generate entitled digital content. Content creator 22 may then distribute the entitled digital content, for example to content consumer 24. Content consumer 24 may then receive the entitled digital content and verify the entitlement of the digital content by securely communicating with verification server 12.

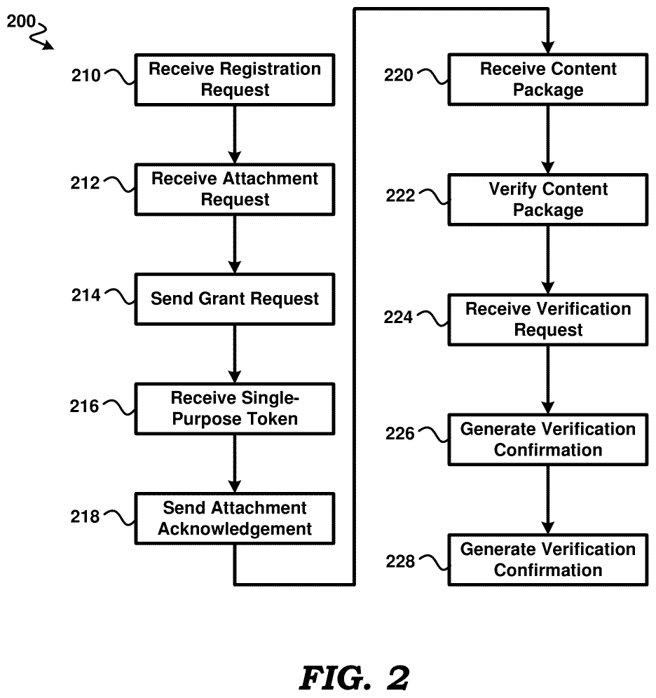

FIG. 2 is a block diagram of method 200 for delegation and verification of a digital content entitlement. In some embodiments, method 200 is performed by verification server 12 of system 100. Method 200 comprises:
step 210: receiving an entitlement registration request from domain server 14, wherein the entitlement registration request comprises a content creator identifier, and an entitlement characteristic identifier;
step 212: receiving an entitlement attachment request from content creator device 16, wherein the entitlement attachment request comprises the content creator identifier, a digital content identifier corresponding to digital content, and the entitlement characteristic identifier;
step 214: sending domain server 14 an entitlement affixation request, wherein the entitlement affixation request comprises the content creator identifier, the digital content identifier, and the entitlement characteristic identifier;
step 216: receiving a single-purpose token from domain server 14, wherein the single-purpose token is associated with the digital content identifier;
step 218: sending content creator device 16 an entitlement attachment acknowledgement, wherein the entitlement attachment acknowledgement comprises the digital content identifier and the single-purpose token;
step 220: receiving a content package from content creator device 16, wherein the content package comprises the single-purpose token and the digital content;
step 222: verifying the content package by confirming a token age between when the single-purpose token was generated by domain server 14 and when the content package was received by verification server 12 is less than a threshold token age;
step 224: receiving an entitlement verification request from content consumer device 18, wherein the entitlement verification request comprises the content creator identifier, the digital content identifier, and the entitlement characteristic identifier;
step 226: generating an entitlement verification confirmation based at least in part on the entitlement verification request; and
step 228: sending the entitlement verification confirmation to content consumer device 18.

Some embodiments of method 200 may further comprise receiving an entitlement challenge request from content creator device 16, and/or content consumer device 18. For example, verification server 12:
receiving an entitlement challenge request from content creator device 16 or content consumer device 18, wherein the entitlement challenge request comprises the content creator identifier, the entitlement characteristic identifier, and a cryptographic signature;
retrieving a cryptographic key associated with the content creator identifier;
verifying the cryptographic signature of the entitlement challenge request with the cryptographic key; and
sending an entitlement challenge confirmation to content creator device 16 or content consumer device 18.

Such an entitlement challenge may be used by content creator 22 or content consumer 24 to demonstrate their entitlement authority in near-real time.

### Some Embodiments

Some embodiments of the present invention comprise securely exchanging information between two or more parties, for example two or more of: verification server 12, domain server 14, content creator device 16, and content consumer device 18. Information may be securely exchanged using one or more cryptographic methods and systems, for example one or more of: public-key cryptography, digital signatures, cryptographic nonces, and cryptographic timestamp protocols.

Some embodiments of the present invention comprise concatenating prior messages to subsequent messages to provide a verifiable message history. For example, where a second communication step in any method disclosed herein is performed subsequent to a first communication step performed in the same method, the second communication step may include sending the message of the first communication step concatenated to the message of the second communication step. Subsequent steps in the method may similar concatenate prior messages, thereby generating a verifiable message history.

In some embodiments, the system verifies the source of data. Platforms that seek to control and identify misinformation can use source verification as one of the inputs into determining data “truth”. Also, algorithms can be built that seek to rate limit message propagation based on social credit, earned by a history of broadcasting reliable information. Validation from the present system can be useful in such situations. In some embodiments, presentation of verifiable information by a first party to a second party can be followed by a challenge-based verification by the second party where the first party is to respond to the challenge with a cryptographically signed response to prove provenance.

The wide adoption of public key cryptography has been difficult for the following reasons:
public key infrastructure (PKI) may require users to use complex commands on UNIX command line systems to create key pairs;
key pairs are generally tied to a machine, such as a desktop or a laptop, and that makes their use in common daily use impractical (e.g. a person is not going to produce their laptop at the entry to a sports arena to validate their ticket with their private key); and
most systems that use key pairs have remained entirely proprietary and siloed, e.g. WhatsApp™, iMessage™, etc. These systems do not allow interoperability, and do not allow management of key pairs as a means of asserting identity

The present system may differ from PKI in one or more of the following ways. The present system may standardize PKI information exchange by embedding all information about the signature along with the signed payload thereby creating a systematic way to obtain the public key corresponding to the signature. This way, PKI collapses into a single step process for the consumer of the signed content such that a structured electronic document (referred to hereafter as a “t-doc”) generated by the system itself encapsulates all the signature and related metadata; any validation system can then automatically look at the signature, procure the public key, and conduct an independent verification of the signed payload.

In some embodiments of the present system, users store their private information on their devices. In some cases, this information can be stored with a cloud system accessible by the user (referred to as the “tsrct cloud”, or the verification server). However, this private information is not accessible to anyone not authorized by the user.

For example, suppose a doctor's office wants access to a user's insurance number. This insurance number is stored in the system (the “tsrct app”) on the user's device. The office may then access the insurance number as follows:
1. The doctor issues a request to the user, signed with their private key, for the insurance information; this document is pushed to the user's mobile device as a t-doc;
2. The user receives the request, and validates it via the tsrct api (i.e. communicating with the verification server) and public key repository;
3. The user grants the doctor access to the information by creating a t-doc that includes their insurance number and sends it back to the doctor; and
4. The doctor receives the insurance information, verifies it with the tsrt api and public key repository, and stores the t-doc locally on their system for later use.

In other embodiments, the doctor's office may access the insurance number as follows:
1. The doctor requests permission to bill the user's insurance;
2. The user issues the doctor a signed authorization with information about the specific insuring company's identifying details;
3. The doctor can now present the authorization to the insurer to file a claim; and
4. The insurer can verify the authorization as coming from the user, and can verify the claim as coming from the specific doctor.

In some embodiments, the system (tsrct) provides a domain verification based automated workflow for generating corporate and governmental private keys. This system uses a cloud based KMS (Key Management System), such as those available from public clouds like Google Cloud™, AWS™, or Microsoft Azure™, to safely create and store private keys. Private keys are never handled by tsrct code or tsrct owned and operated systems.

A third party, for example a corporate or governmental system, may bootstrap itself by generating the private key and sending a signed request with the corresponding public key to register the domain. The system (tsrct) then contacts the domain at a specific endpoint to validate the information. Once information is validated, the tsrct api registers the tsrct id and public key for common use. Newer public keys can be added at any time afterwards.

Additionally, the tsrct technology can be used to solve the problem of “double spending” without the use of cumbersome and energy intensive blockchain and distributed ledger technology. Tsrct enables the exchange of validated and cryptographically secure tokens; the exchange of tokens, combined with challenge verification and/or in-cloud/hosted/distributed cryptographic escrow services can provide fast, scalable solutions to preventing double spending of valuable items like tickets, monetary equivalent tokens, etc.

Additionally, the tsrct technology, along with the tdoc format, can contain verified source code (either raw source code in a programming or domain language) or verified binary container image (e.g. a Docker image) that can be used by the tsrct cloud or a local machine to run conditional or business logic based on verifiable data being produced and exchanged using the tsrct system or tdoc document format.

### Examples

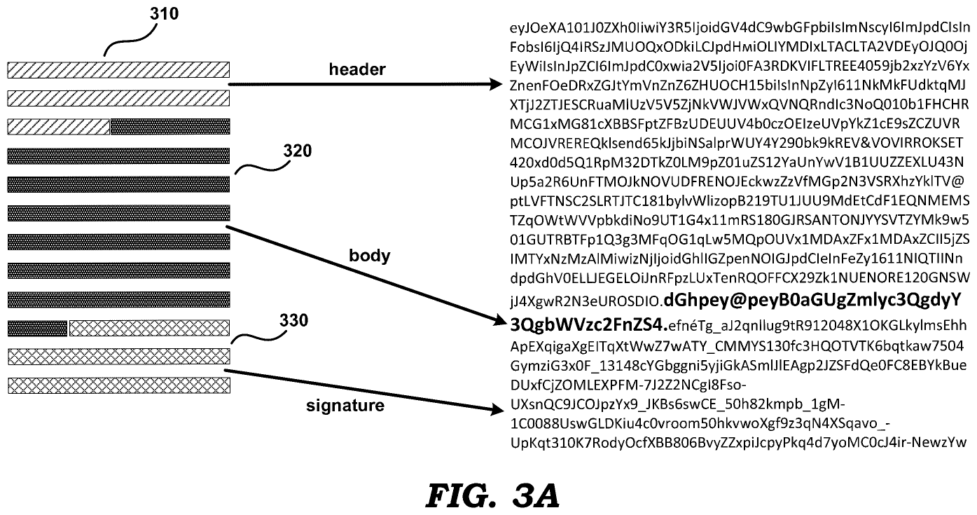

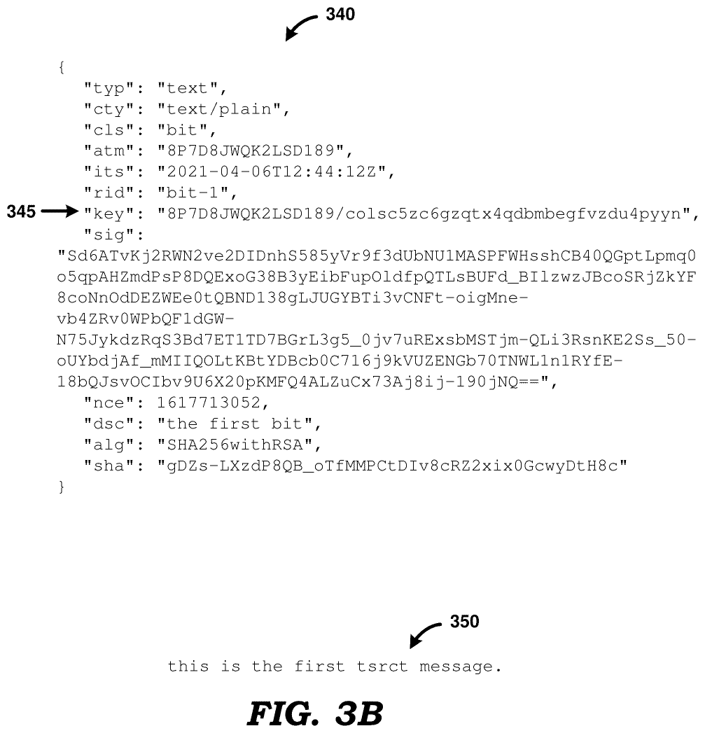

FIG. 3A depicts a sample format of a structured document (t-doc or tdoc) used in a digital content entitlement. Data portion 310 is a header, data portion 320 is a body and data portion 330 is a signature generated from (the contents of) the header (310) and body (320). It may be noted that all of data portion 310, 320 and 330 are shown in encrypted/encoded format.

FIG. 3B depicts a sample content of a structured document (t-doc or tdoc) used in a digital content entitlement. Data portion 340 depicts the content of a header (310). Data portion 340 may be sent as part of an entitlement verification request. Data portion 340 is shown containing a key 345 that may be used to validate signature 330.

Though not shown, data portion 340 includes a Uniform Resource Locator (URL) such as “https://tsrct.io/b/8P7D8JWQK2LSD189.axosu7wr65dpi617ii3rdkep4dmvn7tc” indicating the verification server 12 to which the structured document (t-doc) is to be sent for verification. Data portion 350 shows the content of a body (320).

Thus, the system (tsrct) provides a document standard for information exchange (t-doc). The t-docs are structured text documents that encode digitally signed metadata and content. The contents of t-docs can be verified independently using open-source cryptographic tools.

In addition, the tsrct system also includes a platform facilitating information verification and validation. In one embodiment, the tsrct system is a cloud-based API (Application Programming Interface) service that stores registered public keys and optional public information. The API provides a systematic way to verify and validate t-docs and build custom tools that can run anywhere for any purpose. Such a tsrct system facilitates various types of interactions, some examples of which are described below.

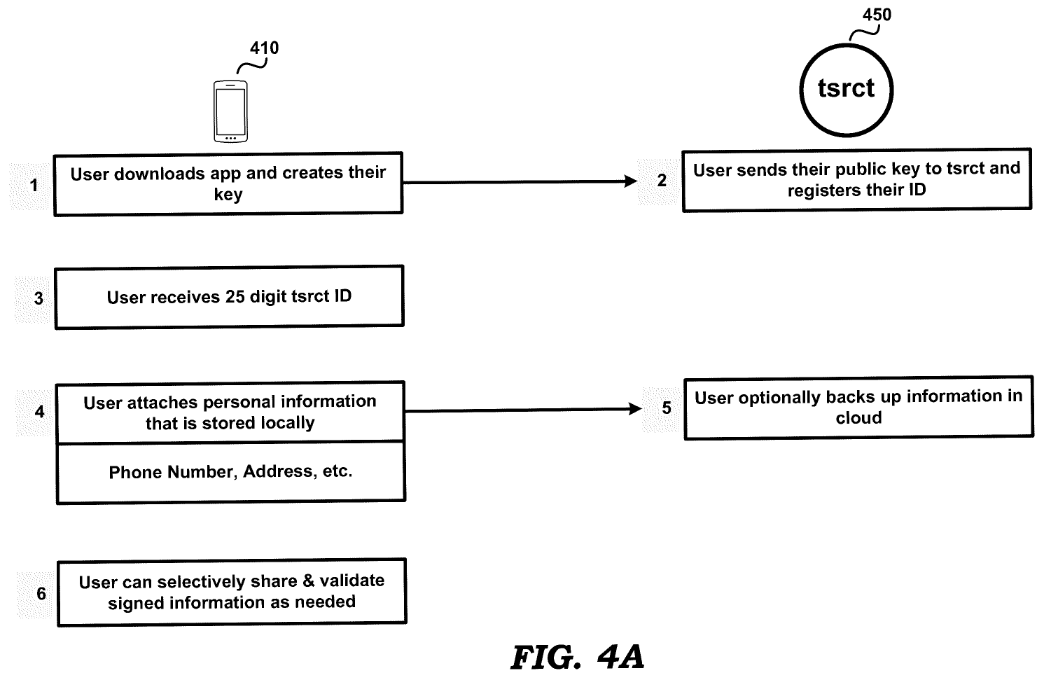

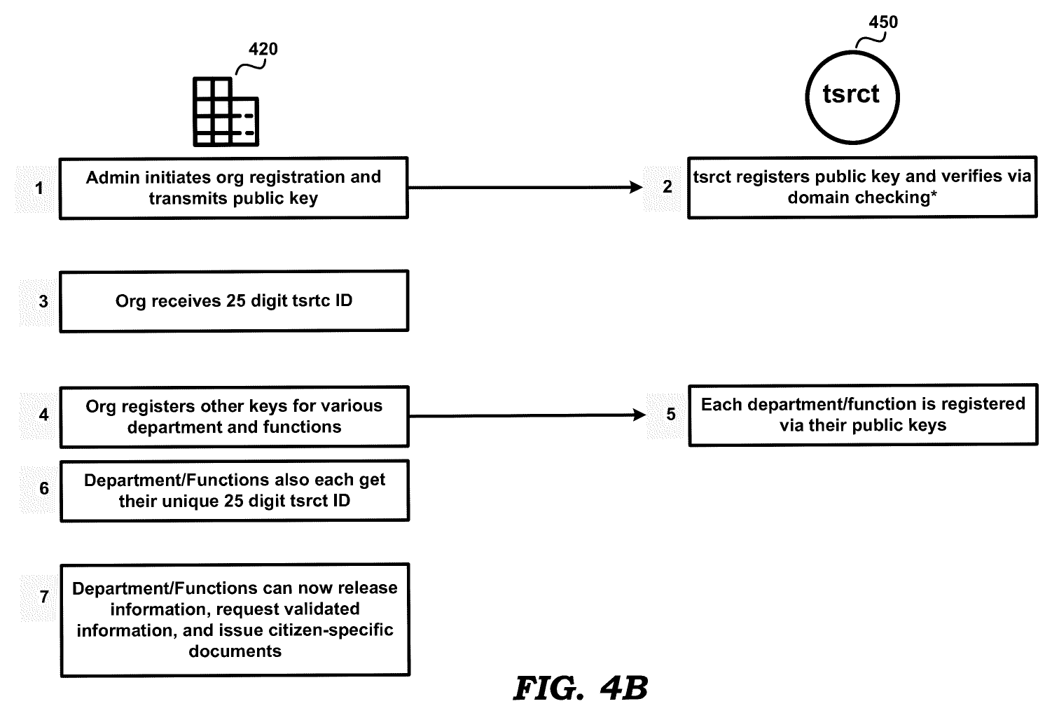

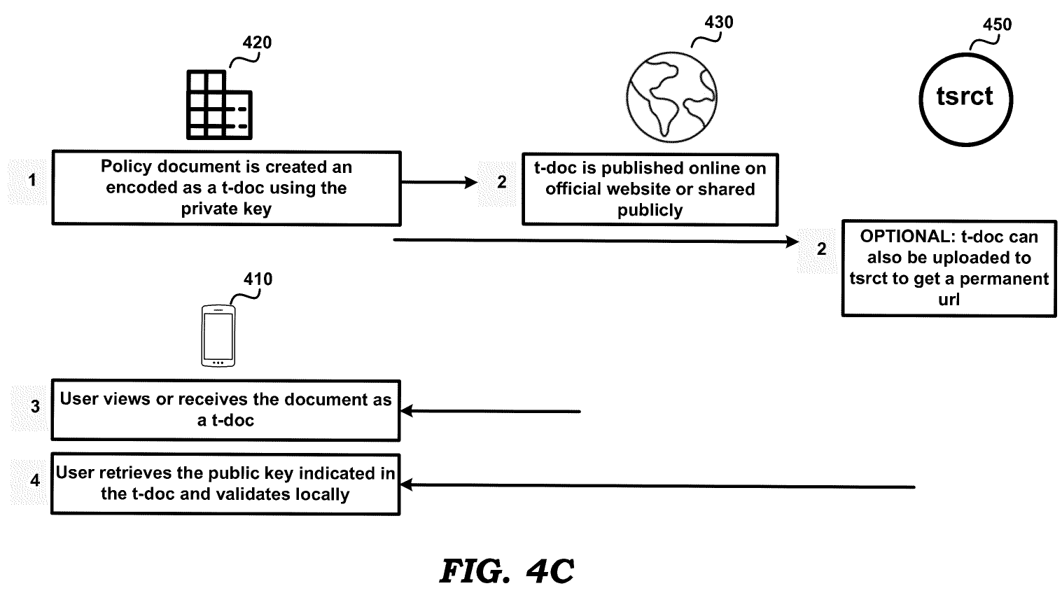

FIG. 4A depicts an example interaction between an individual (such as a citizen or user) and the (tsrct) system. End user system 410 such as a mobile phone is associated with and controlled by the individual to interact with tsrct system 450. The interaction of end user system 410 may go as follows:
1. User downloads (tsrct) app and creates their key
2. User sends their public key to tsrct system 450
3. User receives 25 digit tsrct ID
4. User attaches personal information (Phone Number, Address, etc) that is stored locally
5. User optionally backs up information in cloud
6. User can selectively share & validate signed information as needed

Thus, individuals (citizens) create an account with tsrct system and get a unique ID assigned (t-ID). Their private key stays secure on their smartphone (410), WITH public key is registered with tsrct system. The public t-ID shields private information (e.g. National ID, Phone number, etc.). Individuals are accordingly empowered to share private information selectively to verified entities.

FIG. 4B depicts an example interaction between an organization (such as a corporate or governmental system) and the (tsrct) system. Client systems 420 such as workstations, tablets, mobile phones, etc. are associated with and controlled by the organization, with the users of the organization using these systems to interact with tsrct system 450. The interaction of client systems 420 may go as follows:
1. Admin (user of org) initiates org (organization) registration and transmits public key
2. tsrct system 450 registers public key and verifies via domain checking (for example, using techniques similar to how cloud-based services establish organizational identity via web domain ownership)
3. Org receives 25 digit tsrct ID
4. Org registers other keys for various departments and functions
5. Each department/function is registered via their public keys
6. Departments/Functions also each get their unique 25 digit tsrct ID
7. Departments/Functions can now release information, request validated information, and issue citizen-specific documents

Thus, governments and organizations create an account with tsrct system (450), register their public keys available via an API and domain verification, provide delegated keys and t-IDs to various departments, functions, and employees. The government and departments may then issue official documents with secure signatures. The issued documents can be verified on smartphones. The standard data interchange format (“t-docs”) is used for the official documents.

FIG. 4C depicts an example issue of an official document by an organization. The interaction between end user system 410, client systems 420, public website 430 and tsrct system 450 are shown. The interaction may go as follows:
1. Policy document is created an encoded as a t-doc using the private key
2. t-doc is published online on official website or shared publicly. Optionally, t-doc may also be uploaded to tsrct system 450 to get a permanent URL.
3. User (using end user system 410) views or receives the document as a t-doc
4. User retrieves the public key indicated in the t-doc and validates locally

It may be appreciated that privacy and sovereignty is built-in into the tsrct system. For example. tsrct stores only the public keys in the cloud, while all t-docs representing digitally signed information is stored on citizen phones or in a backup service of their choice. All t-docs produced by an Org/Govt are stored in a Org/Govt. system of choice. The Org/Govt. can utilize tsrct cloud for public data (like proclamations), but that is not required and is entirely optional. Also, t-docs are plain text documents that can encode binary information and can be stored in any common IT system.

### Use Cases

Verification on accounts on proprietary networks (e.g. Twitter, Facebook) has been incredibly problematic. Accounts are easy to fake. There is rampant abuse and brand damage. Verification teams are human powered and cannot scale to demand. The tsrct system offers domain anchored verification where a company can verify their spokespeople across all social networks. A sample flow is described below.

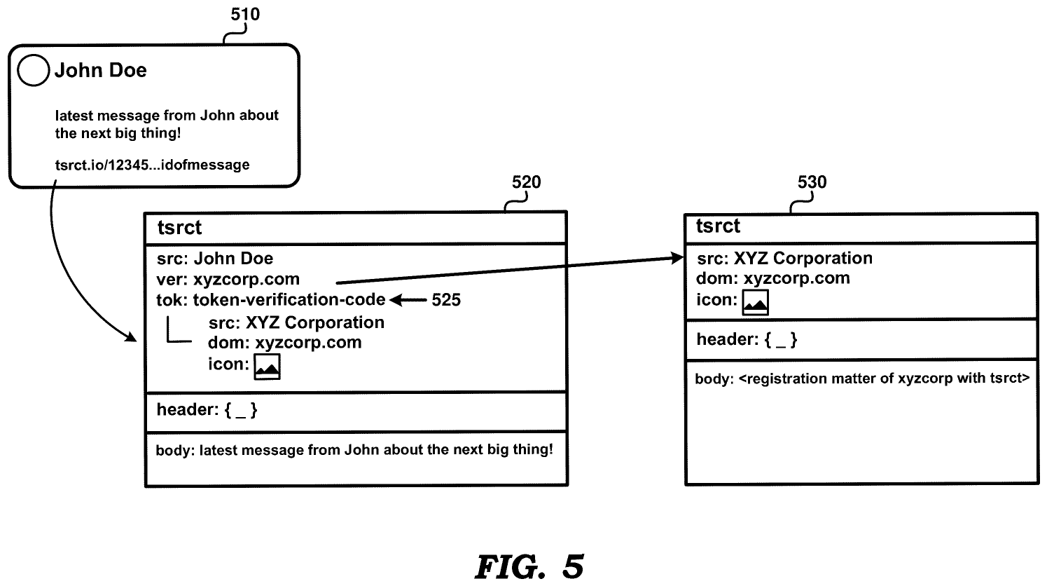

FIG. 5 depicts an example use case of digital content entitlement verification, that is, domain anchored verification. The domain anchored verification may go as follows:
An organization registers its id with a corporate domain verification (say, xyzcorp.com) by sending an entitlement registration request
A spokesperson (say John Doe) creates their own independent tsrct ID
Organization xyzcorp.com issues a verification token to John Doe using the sequence of entitlement attachment request, entitlement affixation request, and an entitlement attachment acknowledgement
John Doe uses the verification token to publish verified messages via Twitter or any other social network. Such publication my entail sending a content package (message), verifying the content package (verified message) and then sending the verified message to a public website. One such published message is shown in display portion 510.
When an end user views John's message, it can be traced to xyzcorp.com as the verifying domain. Display portion 520 shows the content of John's message. The end user may click on verification token 525 to cause sending of an entitlement verification request.
The tsrct system receives the request, performs the verification and sends an entitlement verification confirmation. Display portion 530 displays portion of the confirmation.
It may be noted that the site will load logo icon (in 530) only from xyzcorp.com, and will not allow any other logo to be presented. Logo can also be loaded as a tdoc, so if someone tries to skim the company logo and present it on their tsrct home page, it will fail validation.

It should be noted that xyzcorp.com can revoke the token at any time, at which point John Doe cannot create new content that contains the verification chain shown above. Thus, the tsrct system protects brand identity in displaying domain anchored workflows.

### Digital Processing System

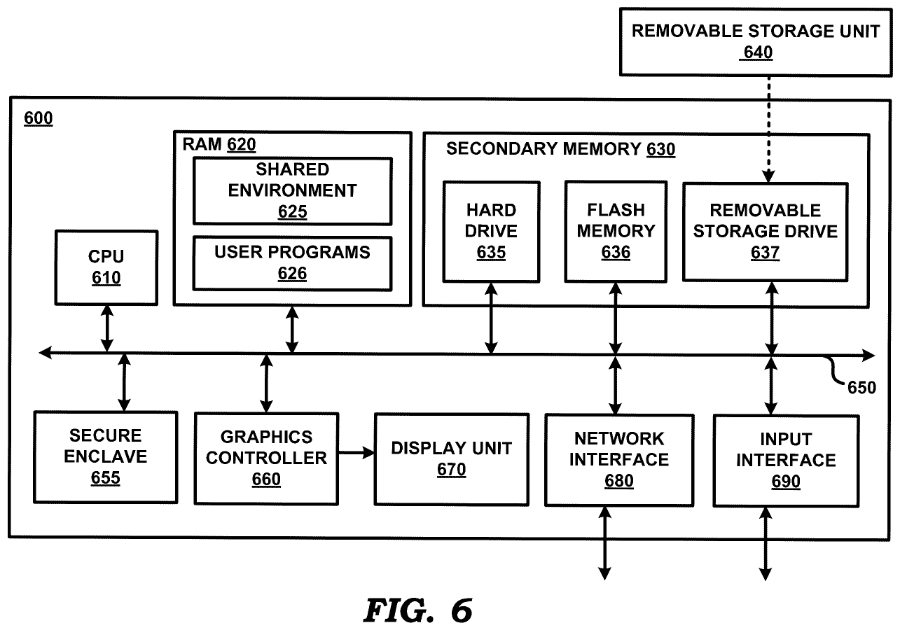

FIG. 6 is a block diagram illustrating the details of a digital processing system in which various aspects of the present disclosure are operative by execution of appropriate executable modules. Digital processing system 600 may correspond to any of systems 12, 14, 16, and 18 of FIG. 1.

Digital processing system 600 may contain one or more processors such as a central processing unit (CPU) 610, random access memory (RAM) 620, secondary memory 630, secure enclave 655, graphics controller 660, display unit 670, network interface 680, and input interface 690. All the components except display unit 670 may communicate with each other over communication path 650, which may contain several buses as is well known in the relevant arts. The components of FIG. 6 are described below in further detail.

CPU 610 may execute instructions stored in RAM 620 to provide several features of the present disclosure. CPU 610 may contain multiple processing units, with each processing unit potentially being designed for a specific task. Alternatively, CPU 610 may contain only a single general-purpose processing unit.

RAM 620 may receive instructions from secondary memory 630 using communication path 650. RAM 620 is shown currently containing software instructions constituting shared environment 625 and/or other user programs 626 (such as other applications, DBMS, etc.). In addition to shared environment 625, RAM 620 may contain other software programs such as device drivers, virtual machines, etc., which provide a (common) run time environment for execution of other/user programs.

Secure enclave 655 is a dedicated secure hardware component designed to protect sensitive information like biometric data, encryption keys (e.g., those shown in FIG. 3B), and payment information. Secure enclave 655 typically operates separately from CPU 610, offering an extra layer of security to prevent unauthorized access or tampering with sensitive data.

Graphics controller 660 generates display signals (e.g., in RGB format) to display unit 670 based on data/instructions received from CPU 610. Display unit 670 contains a display screen to display the images defined by the display signals (e.g., display portions of FIG. 5). Input interface 690 may correspond to a keyboard and a pointing device (e.g., touch-pad, mouse) and may be used to provide inputs (e.g., for the display portions of FIG. 5). Network interface 680 provides connectivity to a network (e.g., using Internet Protocol), and may be used to communicate with other systems connected to the networks.

Secondary memory 630 may contain hard drive 635, flash memory 636, and removable storage drive 637. Secondary memory 630 may store the data (e.g., data portions of FIG. 3A-3B) and software instructions (e.g., for performing the actions of FIGS. 2 and 4A-4C), which enable digital processing system 600 to provide several features in accordance with the present disclosure. The code/instructions stored in secondary memory 630 may either be copied to RAM 620 prior to execution by CPU 610 for higher execution speeds, or may be directly executed by CPU 610.

Some or all of the data and instructions may be provided on removable storage unit 640, and the data and instructions may be read and provided by removable storage drive 637 to CPU 610. Removable storage unit 640 may be implemented using medium and storage format compatible with removable storage drive 637 such that removable storage drive 637 can read the data and instructions. Thus, removable storage unit 640 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 640 or hard disk installed in hard drive 635. These computer program products are means for providing software to digital processing system 600. CPU 610 may retrieve the software instructions, and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 630. Volatile media includes dynamic memory, such as RAM 620. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 650. Transmission media can also take the form of acoustic or light waves, such as those generated during radio-wave and infra-red data communications.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Furthermore, the described features, structures, or characteristics of the disclosure may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the disclosure.

### Interpretation of Terms

Unless the context clearly requires otherwise, throughout the description and the
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms.

Words that indicate directions such as “vertical”, “transverse”, “horizontal”, “upward”, “downward”, “forward”, “backward”, “inward”, “outward”, “vertical”, “transverse”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

Embodiments of the invention may be implemented using specifically designed hardware, configurable hardware, programmable data processors configured by the provision of software (which may optionally comprise “firmware”) capable of executing on the data processors, special purpose computers or data processors that are specifically programmed, configured, or constructed to perform one or more steps in a method as explained in detail herein and/or combinations of two or more of these. Examples of specifically designed hardware are: logic circuits, application-specific integrated circuits (“ASICs”), large scale integrated circuits (“LSIs”), very large scale integrated circuits (“VLSIs”), and the like. Examples of configurable hardware are: one or more programmable logic devices such as programmable array logic (“PALs”), programmable logic arrays (“PLAs”), and field programmable gate arrays (“FPGAs”)). Examples of programmable data processors are: microprocessors, digital signal processors (“DSPs”), embedded processors, graphics processors, math co-processors, general purpose computers, server computers, cloud computers, mainframe computers, computer workstations, and the like. For example, one or more data processors in a control circuit for a device may implement methods as described herein by executing software instructions in a program memory accessible to the processors.

Processing may be centralized or distributed. Where processing is distributed, information including software and/or data may be kept centrally or distributed. Such information may be exchanged between different functional units by way of a communications network, such as a Local Area Network (LAN), Wide Area Network (WAN), or the Internet, wired or wireless data links, electromagnetic signals, or other data communication channel.

For example, while processes or blocks are presented in a given order, alternative examples may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times.

In addition, while elements are at times shown as being performed sequentially, they may instead be performed simultaneously or in different sequences. It is therefore intended that the following claims are interpreted to include all such variations as are within their intended scope.

Software and other modules may reside on servers, workstations, personal computers, tablet computers, image data encoders, image data decoders, PDAs, color grading tools, video projectors, audio-visual receivers, displays (such as televisions), digital cinema projectors, media players, and other devices suitable for the purposes described herein. Those skilled in the relevant art will appreciate that aspects of the system can be practised with other communications, data processing, or computer system configurations, including: Internet appliances, hand-held devices (including personal digital assistants (PDAs)), wearable computers, all manner of cellular or mobile phones, multi-processor systems, microprocessor-based or programmable consumer electronics (e.g., video projectors, audio-visual receivers, displays, such as televisions, and the like), set-top boxes, color-grading tools, network PCs, mini-computers, mainframe computers, and the like.

The invention may also be provided in the form of a program product. The program product may comprise any non-transitory medium which carries a set of computer-readable instructions which, when executed by a data processor, cause the data processor to execute a method of the invention. Program products according to the invention may be in any of a wide variety of forms. The program product may comprise, for example, non-transitory media such as magnetic data storage media including floppy diskettes, hard disk drives, optical data storage media including CD ROMs, DVDs, electronic data storage media including ROMs, flash RAM, EPROMs, hardwired or preprogrammed chips (e.g., EEPROM semiconductor chips), nanotechnology memory, or the like. The computer-readable signals on the program product may optionally be compressed or encrypted.

In some embodiments, the invention may be implemented in software. For greater clarity, “software” includes any instructions executed on a processor, and may include (but is not limited to) firmware, resident software, microcode, and the like. Both processing hardware and software may be centralized or distributed (or a combination thereof), in whole or in part, as known to those skilled in the art. For example, software and other modules may be accessible via local memory, via a network, via a browser or other application in a distributed computing context, or via other means suitable for the purposes described above.

Where a component (e.g. a software module, processor, assembly, device, circuit, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

Various features are described herein as being present in “some embodiments”. Such features are not mandatory and may not be present in all embodiments. Embodiments of the invention may include zero, any one or any combination of two or more of such features. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible).

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

It should be understood that the figures and/or screen shots illustrated in the attachments highlighting the functionality and advantages of the present disclosure are presented for example purposes only. The present disclosure is sufficiently flexible and configurable, such that it may be utilized in ways other than that shown in the accompanying figures.

Further, the purpose of the following Abstract is to enable the Patent Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present disclosure in any way.

What is claimed is:

1. A method performed by a verification server for delegation and verification of a digital content entitlement, the method comprising:
receiving an entitlement registration request from a domain server, wherein the entitlement registration request comprises a content creator identifier identifying an actual content creator, and an entitlement characteristic identifier;
receiving an entitlement attachment request from content creator device, wherein the entitlement attachment request comprises the content creator identifier, a digital content identifier corresponding to digital content, and the entitlement characteristic identifier;
sending to the domain server, an entitlement affixation request, wherein the entitlement affixation request comprises the content creator identifier, the digital content identifier, and the entitlement characteristic identifier;
receiving a single-purpose token from the domain server, wherein the single-purpose token is associated with the digital content identifier, wherein the single-purpose token comprises a first cryptographic signature generated at least in part from the content creator identifier, the digital content identifier, and the entitlement characteristic identifier;
sending to the content creator device an entitlement attachment acknowledgement, wherein the entitlement attachment acknowledgement comprises the digital content identifier and the single-purpose token;
receiving a content package from the content creator device, wherein the content package comprises the single-purpose token and the digital content;
verifying the content package by confirming a token age between when the single-purpose token was generated by the domain server and when the content package was received by the verification server is less than a threshold token age,
wherein an entitlement content is created to contain the single purpose token and also a second cryptographic signature generated from the single-purpose token and the digital content,
wherein the first cryptographic signature is generated using a first cryptographic key belonging to the domain server, and the second cryptographic signature is generated using a second cryptographic key belonging to the actual content creator;
receiving an entitlement verification request from a content consumer device upon a content consumer accessing the entitlement content in the content consumer device, wherein the entitlement verification request comprises the first cryptographic signature, the second cryptographic signature, a first content creator identifier, the digital content identifier, and the entitlement characteristic identifier,
wherein the entitlement verification request is to check whether the first content creator identifier identifies the actual content creator;
generating an entitlement verification confirmation by verifying that the first cryptographic signature belongs to the domain server and the second cryptographic signature belongs to the actual content creator; and
sending the entitlement verification confirmation to the content consumer device.

2. The method according to claim 1, further comprising:
receiving an entitlement challenge request from the content creator device, wherein the entitlement challenge request comprises the content creator identifier, the entitlement characteristic identifier, and a cryptographic signature;
retrieving a cryptographic key associated with the content creator identifier;
verifying the cryptographic signature of the entitlement challenge request with the cryptographic key; and
sending an entitlement challenge confirmation to the content creator device.

3. The method according to claim 1, further comprising:
receiving an entitlement challenge request from the content consumer device, wherein the entitlement challenge request comprises a content creator identifier, the entitlement characteristic identifier, and a cryptographic signature;
retrieving a cryptographic key associated with the content creator identifier;
verifying the cryptographic signature of the entitlement challenge request with the cryptographic key; and
sending an entitlement challenge confirmation to the content consumer device.

4. The method according to claim 1, wherein generating the entitlement verification confirmation based at least in part on the entitlement verification request comprises
retrieving a cryptographic key associated with the content creator identifier, the digital content identifier, and the entitlement characteristic identifier; and
sending the entitlement verification confirmation to the content consumer device comprises sending the cryptographic key to the content consumer device.

5. The method according to claim 1, wherein the entitlement registration request further comprises a cryptographic signature, and the method further comprises:
retrieving a cryptographic key associated with the domain server; and
verifying the cryptographic signature of the entitlement registration request with the cryptographic key.

6. The method according to claim 1, wherein the entitlement attachment request further comprises a cryptographic signature, and the method further comprises:
retrieving a cryptographic key associated with the content creator identifier; and
verifying the cryptographic signature of the entitlement attachment request with the cryptographic key.

7. The method according to claim 1, wherein sending the domain server an entitlement affixation request comprises:
retrieving a cryptographic key associated with the verification server;
generating a cryptographic signature from the content creator identifier, the digital content identifier, and the entitlement characteristic identifier with the cryptographic key; and
wherein the entitlement affixation request further comprises the cryptographic signature.

8. The method according to claim 1, wherein the generating the entitlement verification confirmation comprises:
retrieving a third cryptographic key associated with the content creator identifier, the digital content identifier, and the entitlement characteristic identifier; and
retrieving a fourth cryptographic key associated with the content creator identifier,
wherein the verifying of the first cryptographic signature is performed with the third cryptographic key and the verifying of the second cryptographic signature is performed with the fourth cryptographic key.

9. The method according to claim 9, wherein the single-purpose token further comprises a timestamp representing a time when the single-purpose token was generated by the domain server.

10. The method according to claim 10, wherein the single-purpose token further comprises a nonce, and verifying the content package by confirming the token age comprises calculating a timestamp from the nonce.

11. The method according to claim 1, further comprising verifying the domain server, wherein verifying the domain server comprises:
receiving an initiation message from the domain server, wherein the initiation message comprises a domain name of the domain server, and a cryptographic key;
retrieving a cryptographic signature from a domain name server record associated with the domain name;
verifying the cryptographic signature with the cryptographic key; and
sending an acknowledgement message to the domain server.

12. The method according to claim 1, wherein the entitlement characteristic identifier identifies a characteristic of one or more of the digital content and the content creator identifier,
wherein the characteristic comprises one or more of: a credential, an affiliation, a source, a location, and a time.

13. The method according to claim 1, wherein the threshold token age is five minutes.

14. The method according to claim 1, wherein two or more of the entitlement registration request, the entitlement attachment request, the entitlement affixation request, the entitlement attachment acknowledgement, the content package, the entitlement verification request, and the entitlement verification confirmation, comprise a structured document having a header, a body, and a signature generated from the header and the body.

15. A method performed by a domain server for delegation and verification of a digital content entitlement, the method comprising:
sending an entitlement registration request to a verification server, wherein the entitlement registration request comprises a content creator identifier identifying an actual content creator, and an entitlement characteristic identifier;
receiving from the verification server an entitlement affixation request, wherein the entitlement affixation request comprises the content creator identifier, a digital content identifier, and the entitlement characteristic identifier;
verifying the entitlement affixation request by confirming a delegation of an entitlement represented by the entitlement characteristic identifier to the content creator identifier is active;
generating a single-purpose token from the digital content identifier, wherein the single-purpose token comprises a first cryptographic signature generated at least in part from the content creator identifier, the digital content identifier, and the entitlement characteristic identifier; and
sending a single-purpose token to the verification server,
wherein the actual content creator uses a content creator device to create an entitlement content containing the single purpose token and also a second cryptographic signature generated from the single-purpose token and a digital content,
wherein upon a content consumer accessing the entitlement content in a content consumer device, verification that the first cryptographic signature belongs to the domain server and the second cryptographic signature belongs to the actual content creator is performed.

16. The method according to claim 15, further comprising registering the domain server with the verification server, wherein registering the domain server with the verification server comprises:
generating a cryptographic signature with a private cryptographic key;
storing the cryptographic signature in a domain name server record associated with a domain name of the domain server;
sending an initiation message to the verification server, wherein the initiation message comprises the domain name, and a public cryptographic key paired with the private cryptographic key;
receiving an acknowledgement message from the verification server.

17. The method according to claim 16, wherein the single-purpose token further comprises a timestamp representing a time when the single-purpose token was generated by the domain server.

18. The method according to claim 17, further comprising revoking the single-purpose token, wherein after the revoking, the actual content creator is unable to create new digital content for which the verification is performed.

19. A non-transitory machine-readable medium storing one or more sequences of instructions, wherein execution of said one or more instructions by one or more processors contained in a digital processing system cause said digital processing system to perform the actions of:
receiving an entitlement registration request from a domain server, wherein the entitlement registration request comprises a content creator identifier identifying an actual content creator, and an entitlement characteristic identifier;
receiving an entitlement attachment request from content creator device, wherein the entitlement attachment request comprises the content creator identifier, a digital content identifier corresponding to digital content, and the entitlement characteristic identifier;
sending to the domain server, an entitlement affixation request, wherein the entitlement affixation request comprises the content creator identifier, the digital content identifier, and the entitlement characteristic identifier;
receiving a single-purpose token from the domain server, wherein the single-purpose token is associated with the digital content identifier, wherein the single-purpose token comprises a first cryptographic signature generated at least in part from the content creator identifier, the digital content identifier, and the entitlement characteristic identifier;
sending to the content creator device an entitlement attachment acknowledgement, wherein the entitlement attachment acknowledgement comprises the digital content identifier and the single-purpose token;
receiving a content package from the content creator device, wherein the content package comprises the single-purpose token and the digital content;
verifying the content package by confirming a token age between when the single-purpose token was generated by the domain server and when the content package was received by the verification server is less than a threshold token age,
wherein an entitlement content is created to contain the single purpose token and also a second cryptographic signature generated from the single-purpose token and the digital content,
wherein the first cryptographic signature is generated using a first cryptographic key belonging to the domain server, and the second cryptographic signature is generated using a second cryptographic key belonging to the actual content creator;
receiving an entitlement verification request from a content consumer device upon a content consumer accessing the entitlement content in the content consumer device, wherein the entitlement verification request comprises the first cryptographic signature, the second cryptographic signature, a first content creator identifier, the digital content identifier, and the entitlement characteristic identifier,
wherein the entitlement verification request is to check whether the first content creator identifier identifies the actual content creator;
generating an entitlement verification confirmation by verifying that the first cryptographic signature belongs to the domain server and the second cryptographic signature belongs to the actual content creator; and
sending the entitlement verification confirmation to the content consumer device.
